(19) United States
(12) Patent Application Publication
(10) Pub. No.: US 2026/0288387 A1
(43) Pub. Date: Sep. 24, 2026

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Yuta Nakayama, Kanagawa (JP)

(73) Assignee: FUJIFILM Business Innovation Corp., Tokyo (JP)

(21) Appl. No.: 19/303,796

(22) Filed: Aug. 19, 2025

(30) Foreign Application Priority Data
Mar. 18, 2025 (JP) 2025-043370

(51) Int. Cl. G06F 3/12

(52) U.S. Cl. CPC G06F 3/1226; G06F 3/1203; G06F 3/1255; G06F 3/1288

(57) ABSTRACT

An information processing system includes a processor configured to: be able to start server-mediated processing and direct processing, the server-mediated processing causing a processing apparatus to execute a process according to a processing command from a user through mediation by a server, the direct processing causing a processing apparatus to execute a process according to a processing command from a user without mediation by a server; acquire a list of apparatuses used by each user and predefined user group information, in which the list being accumulated and stored in the server through repetition of the server-mediated processing in response to instructions from a plurality of users, the list indicating a plurality of combinations each consisting of a user ID for identifying a user and an apparatus ID for identifying a processing apparatus that has executed a process according to a processing command from the user, in which the user group information indicates grouping of the plurality of users; and before starting the direct processing in response to an instruction from a target user, based on the list of apparatuses used by each user and the user group information, inform the target user about the processing apparatus indicated by the apparatus ID associated with one or more users being different from the target user and belonging to a user group to which the target user belongs.

### CROSS-REFERENCE TO RELATED APPLICATIONS

This application is based on and claims priority under 35 USC 119 from Japanese Patent Application No. 2025-043370 filed Mar. 18, 2025.

### BACKGROUND

### (i) Technical Field

The present disclosure relates to an information processing system and a non-transitory computer readable medium.

### (ii) Related Art

An information processing system including a user terminal and a processing apparatus is known, and the processing apparatus in such a system is configured to execute a process based on a processing command transmitted from the user terminal, which is used by a user. An information processing system of this kind that has been proposed in the related art further includes a server to which a processing command is transmitted from a user terminal, and the server then transmits the processing command to a processing apparatus, which executes a process according to the processing command. In the present specification, such a process of transmitting a processing command from a user terminal to a processing apparatus via a server is referred to as “server-mediated processing”.

For example, Japanese Unexamined Patent Application Publication No. 2017-049978 discloses an information processing system including a location free (LF) management server, a personal computer (PC) serving as a user terminal, and a plurality of multifunction peripherals each serving as a processing apparatus. In the information processing system, the PC transmits print data to the LF management server, and a multifunction peripheral selected by a user receives the user's print data from the LF management server and executes a printing process, and when the user selects a multifunction peripheral, the user is informed about the status of the multifunction peripheral.

### SUMMARY

Since processing commands transmitted from a plurality of user terminals pass through a server in server-mediated processing, the server is able to accumulate and store information indicating transmission sources (that is, users or user terminals) and transmission destinations (that is, processing apparatuses) of a plurality of processing commands. Based on the information accumulated and stored in this manner, for each user, information indicating a processing apparatus that has executed a process according to a processing command based on an instruction from the user can be obtained (the information being referred to as a “list of apparatuses used by each user” in the present specification). The list of apparatuses used by each user may be updated each time a user transmits a processing command to the server. Based on the list of apparatuses used by each user, a processing apparatus that has been caused by a user to execute a process according to a processing command may be identified, and the identified processing apparatus is referred to as an apparatus previously used. The user is informed about the apparatus previously used by the user and thereby can easily identify a processing apparatus previously used by the user even when a plurality of processing apparatuses are available to the user.

Even in an information processing system including user terminals, a server, and processing apparatuses, a processing command is sometimes transmitted from a user terminal to a processing apparatus without mediation by the server. A processing command is transmitted from a user terminal to a processing apparatus without mediation by the server, for example, when communication between the user terminal and the server malfunctions, when the server does not properly provide a service of processing a processing command, or when a user does not want a process mediated by the server. In the present specification, “direct processing” refers to such a process of transmitting a processing command from a user terminal to a processing apparatus without mediation by the server.

Even when direct processing is executed, the user may be informed about the apparatuses previously used by the user. For example, the user terminal receives the list of apparatuses used by each user from the server and saves the list to the memory in the user terminal at a predetermined time (for example, a time that the above-described server-mediated processing is executed). In this manner, even when direct processing is executed, based on a list of apparatuses used by each user stored in the memory in the user terminal, an apparatus previously used, which is a processing apparatus previously caused to execute a process according to a processing command by a user who uses the user terminal, may be identified, and the user may be informed about the apparatus previously used by the user.

When a user terminal has not received the list of apparatuses used by each user from the server for a long time, the list of apparatuses used by each user stored in the memory in the user terminal becomes an outdated list (that is, a list received from the server a considerably long time ago). Such an outdated list of apparatuses used by each user may include a processing apparatus that is not to be used at the present time (for example, a processing apparatus that is unavailable or that has been relocated), and if the user is informed about the list of apparatuses used by each user, the user is informed about the processing apparatus that is not to be used at the present time.

While the above description relates to an issue that may occur when the server obtains a list of apparatuses used by each user and informs a user about apparatuses previously used by the user, a similar issue may occur when the server obtains, for each user terminal, information indicating a processing apparatus that has executed a process according to a processing command transmitted from the user terminal (the information being referred to as a “list of apparatuses used by each terminal” in the present specification) based on accumulated and stored information. In such a case, the server identifies an apparatus previously used, which is a processing apparatus caused to execute a process according to a processing command previously transmitted from a user terminal, and informs the user who uses the user terminal about apparatuses previously used by the user terminal.

Aspects of non-limiting embodiments of the present disclosure relate to reducing the likelihood of informing a user about a processing apparatus that is not to be used during direct processing, compared with a case of informing a user about apparatuses previously used based on a list of apparatuses used by each user or a list of apparatuses used by each terminal stored in a user terminal used by the user.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to: be able to start server-mediated processing and direct processing, the server-mediated processing causing a processing apparatus to execute a process according to a processing command from a user through mediation by a server, the direct processing causing a processing apparatus to execute a process according to a processing command from a user without mediation by a server; acquire a list of apparatuses used by each user and predefined user group information, wherein the list is accumulated and stored in the server through repetition of the server-mediated processing in response to instructions from a plurality of users, the list indicating a plurality of combinations each consisting of a user ID for identifying a user and an apparatus ID for identifying a processing apparatus that has executed a process according to a processing command from the user, wherein the user group information indicates grouping of the plurality of users; and before starting the direct processing in response to an instruction from a target user, based on the list of apparatuses used by each user and the user group information, inform the target user about the processing apparatus indicated by the apparatus ID associated with one or more users being different from the target user and belonging to a user group to which the target user belongs.

### BRIEF DESCRIPTION OF THE DRAWINGS

An exemplary embodiment of the present disclosure will be described in detail based on the following figures, wherein:

FIG. 1 is a schematic block diagram of a processing system according to the present exemplary embodiment;

FIG. 2 is a schematic block diagram of a server;

FIG. 3 is a conceptual diagram illustrating an example of a list of apparatuses used by each user;

FIG. 4 is a conceptual diagram illustrating an example of user group information;

FIG. 5 is a conceptual diagram illustrating an example of a list of apparatuses used by each group;

FIG. 6 is a flowchart illustrating a process of updating a list of apparatuses used by each group;

FIG. 7 is a schematic block diagram of a user terminal; and

FIG. 8 is a flowchart illustrating a process executed by the user terminal.

### DETAILED DESCRIPTION

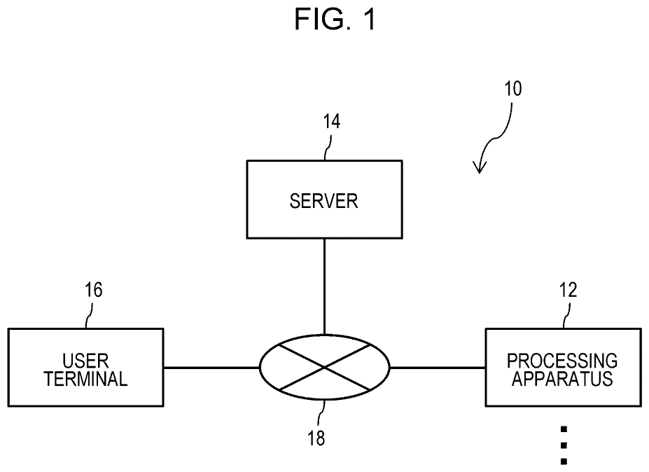

FIG. 1 is a schematic block diagram of a processing system 10 according to the present exemplary embodiment. The processing system 10 includes a plurality of processing apparatuses 12, a server 14, and one or more user terminals 16 each serving as an information processing system. The processing apparatuses 12, the server 14, and the one or more user terminals 16 are communicably connected to each other via a communication network 18, such as a local area network (LAN) or a wide area network (WAN).

In the processing system 10 according to the exemplary embodiment, each of the processing apparatuses 12 serving as an image processing apparatus is caused to execute a process according to a job that is a processing command transmitted from one of the one or more user terminals 16. While not limited thereto, in the present exemplary embodiment, the processing system 10 is a print processing system in which each of the processing apparatuses 12 is an image forming apparatus, such as a multifunction peripheral or a printer, and, based on a print job transmitted from one of the one or more user terminals 16, the processing apparatus 12 serving as an image forming apparatus is configured to execute a printing process according to the print job.

The server 14 includes, for example, a server computer. The server 14 provides a user with a process management service of receiving a processing command from a user terminal 16 and transmitting a print command to a processing apparatus 12 in response to a request from the processing apparatus 12. In this way, in the processing system 10, server-mediated processing is executable, in which the processing apparatus 12 is caused to execute a process according to a processing command from a user through mediation by the server 14.

In the present exemplary embodiment, since the processing system 10 is a print processing system, the server 14 is configured to provide the user with a cloud print management service in which a print job from the user is transmitted to a processing apparatus 12 in response to a request from the processing apparatus 12. A common printer driver is installed on the user terminal 16 and is capable of generating a print job supported by all the processing apparatuses 12 included in the processing system 10. The user uses the common printer driver to configure various print settings and transmits from the user terminal 16 to the server 14 a print job including a configured print setting and a user ID for identifying the user. At this time, the user does not need to designate a processing apparatus 12 to execute the printing process according to the print job. The user moves to a position in front of a processing apparatus 12 that is to execute the process according to the print job and logs in to the processing apparatus 12. While presenting the user ID of the user, which is obtained by the login, the processing apparatus 12 requests the print job for the user from the server 14. In response to the request, the server 14 transmits the print job for the user to the processing apparatus 12. The processing apparatus 12 executes the printing process according to the received print job.

As described above, the user does not need to designate the processing apparatus 12 to execute a printing process according to a print job in the processing system 10 when transmitting the print job from the user terminal 16 to the server 14. Thus, after transmitting the print job, the user is able to select any processing apparatus 12 to execute the printing process according to the print job.

The processing system 10 is also capable of executing direct processing in which a process according to a processing command from a user is executed by the processing apparatus 12 without mediation by the server 14. In the direct processing, the user transmits a processing command directly (without mediation by the server 14) from the user terminal 16 to a processing apparatus 12 and causes the processing apparatus 12 to execute the process according to the processing command.

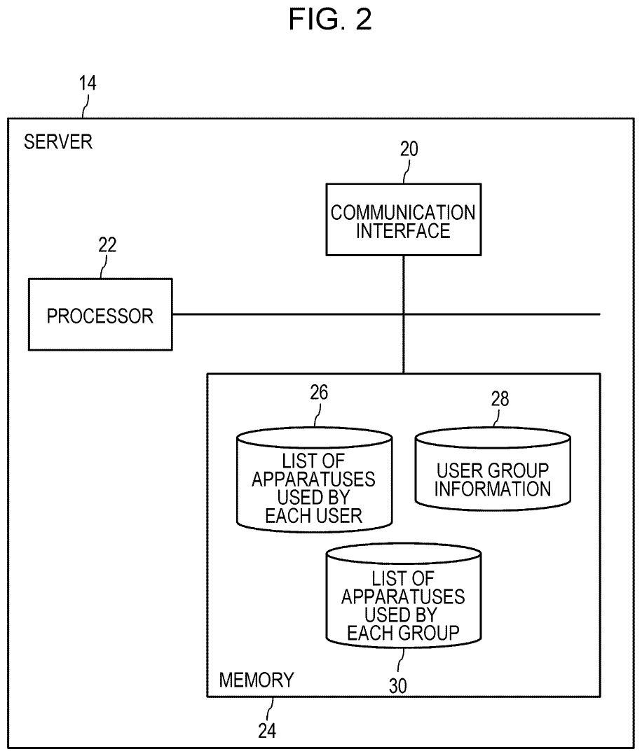

FIG. 2 is a schematic block diagram of the server 14.

A communication interface 20 includes, for example, a network adapter. The communication interface 20 provides a function of communicating with other devices, in particular, the processing apparatuses 12 and the one or more user terminals 16 via the communication network 18.

A processor 22 includes, for example, a central processing unit (CPU). The processor 22 is communicably connected to the communication interface 20 and a memory 24 described below via a data bus. The processor 22 is configured to execute various types of processing for controlling the components of the server 14 and providing the above-described process management service based on a server program stored in the memory 24.

The memory 24 includes, for example, a hard disk drive (HDD), an embedded multimedia card (eMMC), a read only memory (ROM), and/or a random access memory (RAM). The memory 24 stores the server program for operating the components of the server 14. The server program may be stored in a non-transitory computer readable storage medium such as a universal serial bus (USB) memory or an SD card. The processor 22 may load the server program from such a storage medium and execute the server program.

As illustrated in FIG. 2, the memory 24 stores a list of apparatuses used by each user 26, user group information 28, and a list of apparatuses used by each group 30. These contents are accumulated and stored in the memory 24 through repetition of the server-mediated processing in response to instructions from a plurality of users (in other words, from a plurality of user terminals 16).

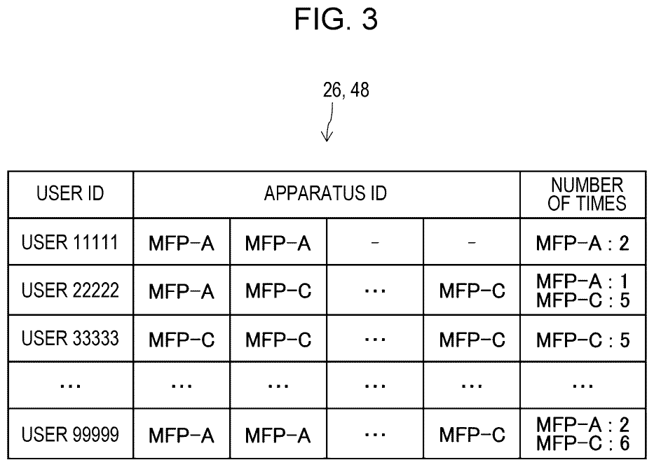

FIG. 3 is a conceptual diagram illustrating an example of the list of apparatuses used by each user 26. The list of apparatuses used by each user 26 indicates a plurality of combinations each consisting of a user ID for identifying a user and an apparatus ID for identifying a processing apparatus 12 that has executed a process according to a processing command from the user (that is, the processing apparatus 12 being an apparatus previously used by the user). For example, the list of apparatuses used by each user 26 illustrated in FIG. 3 indicates that a user indicated by a user ID “user 11111” (hereinafter simply referred to as “user 11111”) previously caused the processing apparatus 12 indicated by an apparatus ID “MFP-A” (hereinafter simply referred to as the processing apparatus “MFP-A”) to execute a process according to a processing command through server-mediated processing. The list indicates that “user 22222” previously caused the processing apparatuses “MFP-A” and “MFP-C” to execute processes according to processing commands through server-mediated processing. The list of apparatuses used by each user 26 may also store the number of times that each user has caused each processing apparatus 12 to execute a process according to a processing command.

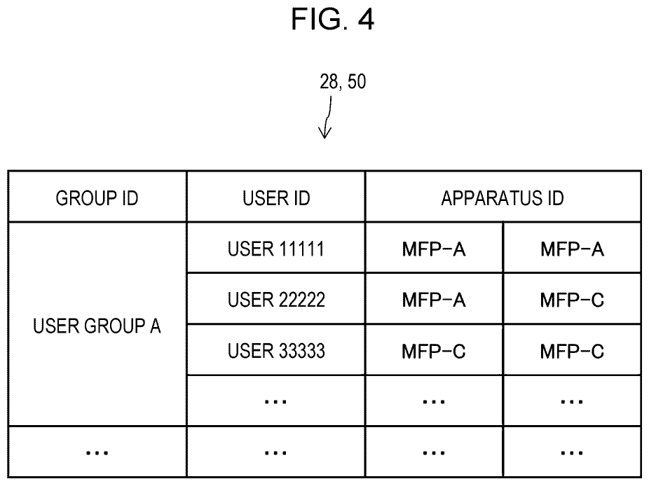

FIG. 4 is a conceptual diagram illustrating an example of the user group information 28. The user group information 28 indicates grouping of a plurality of users. In the present exemplary embodiment, a group ID for identifying a user group is associated with user IDs of users belonging to the user group in the user group information 28. The user group information 28 illustrated in FIG. 4 indicates that three users “user 11111”, “user 22222”, and “user 33333” belong to a user group indicated by a group ID “user group A” (hereinafter simply referred to as “user group A”). Users belonging to each user group are predefined by the administrator of the processing system 10 or the users themselves.

Each user ID may also be associated with an apparatus ID for identifying the processing apparatus 12 that has executed the process according to a processing command from the user in the user group information 28 as in the list of apparatuses used by each user 26.

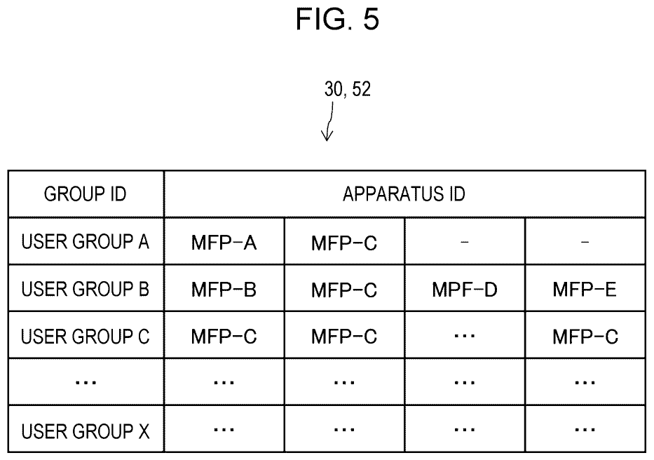

FIG. 5 is a conceptual diagram illustrating an example of the list of apparatuses used by each group 30. In the list of apparatuses used by each group 30, a group ID for identifying a user group is associated with an apparatus ID for identifying the processing apparatus 12 that has executed a process according to a processing command based on an instruction from a user belonging to the user group. The list of apparatuses used by each group 30 may be obtained from the list of apparatuses used by each user 26 and the user group information 28. In other words, the list of apparatuses used by each group 30 contains information obtained from both the list of apparatuses used by each user 26 and the user group information 28. In the list of apparatuses used by each group 30, each group ID may also be associated with user IDs of users belonging to the corresponding user group.

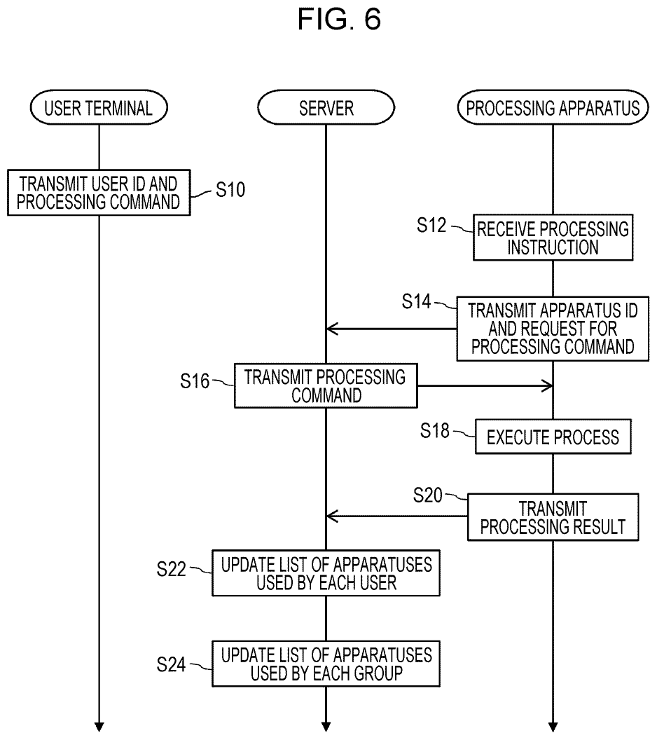

FIG. 6 is a flowchart illustrating a process of updating the list of apparatuses used by each group 30. Description will be given with regard to the process of updating the list of apparatuses used by each user 26, the user group information 28, and the list of apparatuses used by each group 30 with reference to FIG. 6.

In step S10, in response to an instruction from a user, the user terminal 16 transmits the user ID of the user and a processing command to the server 14.

In step S12, the user goes to a position in front of the processing apparatus 12 that the user wants to execute the process according to the processing command, logs in to the processing apparatus 12, and inputs a processing instruction.

In step S14, while presenting the user ID of the user, which is obtained by the login, the processing apparatus 12 requests from the server 14 the processing command transmitted by the user to the server 14.

In step S16, the processor 22 in the server 14 transmits the processing command to the processing apparatus 12.

In step S18, the processing apparatus 12 executes the process according to the processing command.

In step S20, the processing apparatus 12 transmits the apparatus ID of the processing apparatus 12 and a processing result to the server 14.

In step S22, in response to receiving the processing result, the processor 22 updates the list of apparatuses used by each user 26. To be specific, the processor 22 registers the user ID received in step S10 and the apparatus ID received in step S14 in the list of apparatuses used by each user 26 in association with each other. When the combination consisting of the user ID and the apparatus ID is contained in the list of apparatuses used by each user 26, the processor 22 increments the number of times of use of the combination consisting of the user ID and the apparatus ID. The processor 22 also updates the user group information 28 if, in the user group information 28 as in the list of apparatuses used by each user 26, each user ID is also associated with an apparatus ID for identifying the processing apparatus 12 that has executed a process according to the processing command from the user.

In step S24, the processor 22 updates the list of apparatuses used by each group 30 based on the list of apparatuses used by each user 26 updated in step S22.

The processor 22 is configured to transmit the list of apparatuses used by each user 26 and the user group information 28 to the user terminal 16 at a predetermined time. For example, the processor 22 is configured to transmit the list of apparatuses used by each user 26 and the user group information 28 to the user terminal 16 at a time that a client tool for transmitting a processing command is activated on the user terminal 16. In this way, the server 14 and the user terminal 16 share the list of apparatuses used by each user 26 and the user group information 28. While the server 14 is able to receive processing commands from a plurality of user terminals 16, when a certain user terminal 16 has not received the list of apparatuses used by each user 26 and the user group information 28 from the server 14 for a while, the list of apparatuses used by each user 26 and the user group information 28 held by the user terminal 16 may differ from the list of apparatuses used by each user 26 and the user group information 28 stored in the memory 24 in the server 14. As described above, since the list of apparatuses used by each group 30 contains information obtained from both the list of apparatuses used by each user 26 and the user group information 28, the server 14 and the user terminal 16 may share the list of apparatuses used by each group 30 instead of or in addition to the list of apparatuses used by each user 26 and the user group information 28.

Preferably, the processor 22 may transmit the list of apparatuses used by each user 26 and the user group information 28 to a processing apparatus 12 at a predetermined time. For example, when transmitting a processing command in response to a request from a processing apparatus 12, the processor 22 also transmits the list of apparatuses used by each user 26 and the user group information 28 to the processing apparatus 12. In this way, the processing apparatus 12 and the server 14 share the list of apparatuses used by each user 26 and the user group information 28. The processing apparatus 12 and the server 14 may share the list of apparatuses used by each group 30 instead of or in addition to the list of apparatuses used by each user 26 and the user group information 28.

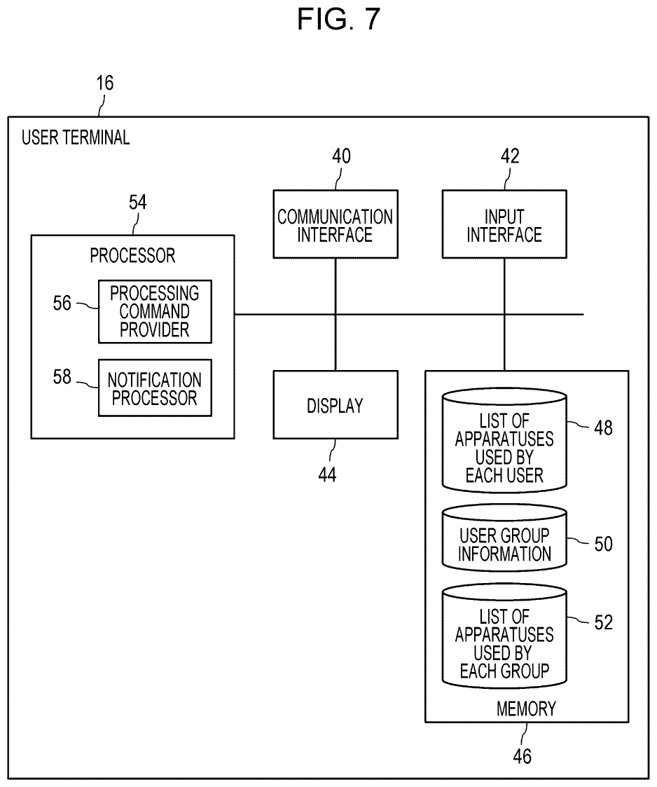

FIG. 7 is a schematic block diagram of the user terminal 16. The user terminal 16 may be, for example, a personal computer (PC), a tablet terminal, or a smartphone. The user terminal 16 is used by a user of the processing system 10.

A communication interface 40 includes, for example, a network adapter. The communication interface 40 provides a function of communicating with other devices, in particular, the processing apparatuses 12 and the server 14 via the communication network 18.

An input interface 42 includes, for example, a keyboard, a mouse, a button, or a touch panel. The input interface 42 is used when a user inputs an instruction to the user terminal 16.

A display 44 includes, for example, a liquid crystal display or an organic electroluminescence (EL) display. Various screens are displayed in the display 44 in response to instructions from a processor 54 described below.

A memory 46 includes, for example, an HDD, an eMMC, a ROM, and/or a RAM. The memory 46 stores an information processing program for operating the components of the user terminal 16. The information processing program may be stored in a non-transitory computer readable storage medium such as a USB memory or an SD card. The user terminal 16 may load the information processing program from such a storage medium and execute the information processing program. The above-described common printer driver is installed on the memory 46.

As illustrated in FIG. 7, the memory 46 stores a list of apparatuses used by each user 48, user group information 50, and a list of apparatuses used by each group 52 received from the server 14. As described above, the list of apparatuses used by each user 26 stored in the memory 24 in the server 14 and the list of apparatuses used by each user 48 stored in the memory 46 in the user terminal 16 may have different contents, the user group information 28 stored in the memory 24 and the user group information 50 stored in the memory 46 may have different contents, and the list of apparatuses used by each group 30 stored in the memory 24 and the list of apparatuses used by each group 52 stored in the memory 46 may have different contents, thereby being denoted by different reference numerals.

When a processing apparatus 12 and the server 14 share the list of apparatuses used by each user 26 and the user group information 28, or the list of apparatuses used by each group 30, as described above, the user terminal 16 may receive the list of apparatuses used by each user 48 and the user group information 50, or the list of apparatuses used by each group 52 from the processing apparatus 12. In this way, even when these pieces of information cannot be received from the server 14 for some reason, the user terminal 16 can acquire these pieces of information from the processing apparatus 12.

The processor 54 includes, for example, a CPU. The processor 54 is communicably connected to the communication interface 40, the input interface 42, the display 44, and the memory 46 via a data bus. The processor 54 is configured to control the components of the user terminal 16 in accordance with the information processing program stored in the memory 46. In particular, the processor 54 provides functions as a processing command provider 56 and a notification processor 58.

The processing command provider 56 is configured to, in response to an instruction from a user, transmit the user ID of the user and a processing command to the server 14. In this way, the processing command provider 56 starts server-mediated processing. The processing command provider 56 is configured to transmit a processing command directly (without mediation by the server 14) to the processing apparatus 12 in response to an instruction from the user. In this way, the processing command provider 56 starts direct processing.

The notification processor 58 is configured to inform the user about one or more apparatuses previously used by the user based on the list of apparatuses used by each user 48 received from the server 14 and stored in the memory 46. For example, immediately before the processing command provider 56 starts server-mediated processing (in other words, immediately before the processing command provider 56 transmits a processing command to the server 14), the notification processor 58 informs the user about one or more apparatuses previously used by the user. In the present exemplary embodiment, the notification processor 58 receives the list of apparatuses used by each user 48 from the server 14 at a time that the common printer driver is activated in response to an instruction from the user, and the notification processor 58 displays one or more apparatuses previously used by the user on the screen of the common printer driver based on the list of apparatuses used by each user 48.

In this way, the user can easily recognize the one or more apparatuses previously used among the plurality of processing apparatuses 12 included in the processing system 10 and can determine, based on the recognized apparatuses previously used, a processing apparatus 12 to execute a process according to a processing request at this time.

Immediately before the processing command provider 56 starts direct processing (in other words, immediately before the processing command provider 56 transmits a processing command to the processing apparatus 12), the notification processor 58 informs the user about one or more apparatuses previously used by the user. Although the processing command provider 56 does not transmit a processing request to the server 14 in this case, the notification processor 58 receives the list of apparatuses used by each user 48 from the server 14 at a time that the common printer driver is activated in response to an instruction from the user, and the notification processor 58 displays one or more apparatuses previously used by the user on the screen of the common printer driver based on the list of apparatuses used by each user 48.

When a considerable amount of time has elapsed since the previous reception of the list of apparatuses used by each user 48 from the server 14 and the list of apparatuses used by each user 26 remains unreceivable from the server 14, the list of apparatuses used by each user 48 stored in the memory 46 becomes considerably old. Even in such a case, the user may be informed about apparatuses previously used based on the list of apparatuses used by each user 48 stored in the memory 46. However, since the list of apparatuses used by each user 48 stored in the memory 46 is outdated, apparatuses previously used by the user indicated based on the list of apparatuses used by each user 48 may include a processing apparatus 12 that is not to be used at the present time, such as a processing apparatus 12 that has recently become unavailable. In such a case, the notification processor 58 informs the user about a processing apparatus 12 that is not to be used at the present time.

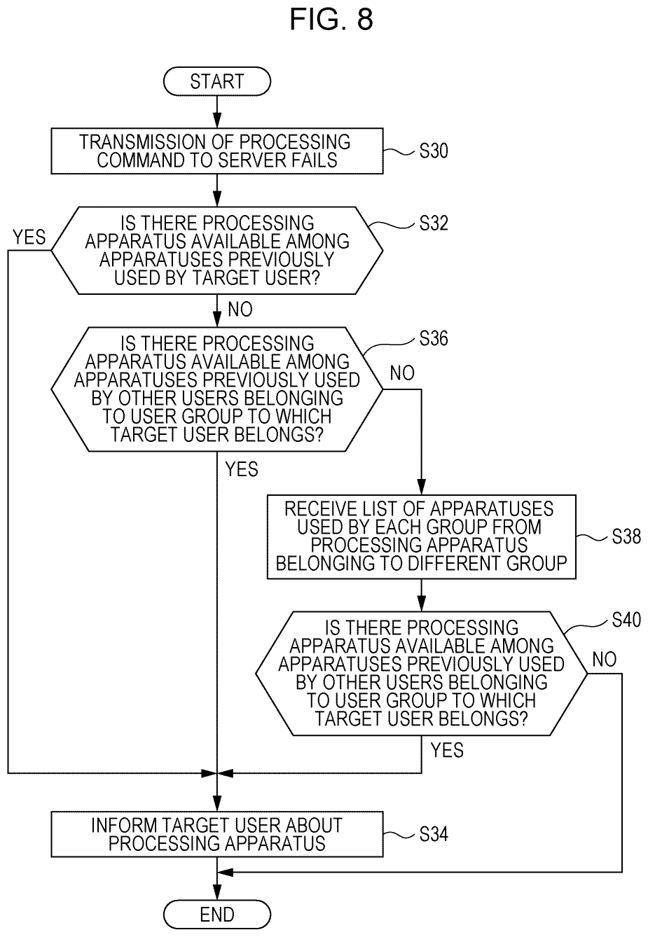

Thus, in the present exemplary embodiment, to reduce the likelihood of informing the user about a processing apparatus 12 that is not to be used at the present time, based on the list of apparatuses used by each user 48 and the user group information 50, the user is informed about a processing apparatus 12 indicated by an apparatus ID associated with a user being different from the user and belonging to the user group to which the user belongs. With reference to the flowchart illustrated in FIG. 8, detailed description will be given below with regard to a process executed by the user terminal 16 when a certain user (referred to as a “target user”) transmits a processing request from the user terminal 16.

At the start of the flowchart illustrated in FIG. 8, the memory 46 in the user terminal 16 used by the target user is assumed to store the list of apparatuses used by each user 48, the user group information 50, and the list of apparatuses used by each group 52, which are received from the server 14 during the previous server-mediated processing. The memory 46 is assumed to store the list of apparatuses used by each user 48 having the content illustrated in FIG. 3, the user group information 50 having the content illustrated in FIG. 4, and the list of apparatuses used by each group 52 having the content illustrated in FIG. 5, and the user ID of the target user is assumed to be “user 11111”.

In step S30, in response to an instruction from the target user, the processing command provider 56 transmits a processing command to the server 14 and attempts to start server-mediated processing. However, the condition of the communication between the server 14 and the user terminal 16 is assumed to be poor, and the transmission of the processing command to the server 14 is assumed to have failed. At the same time, it is assumed that the latest version of the list of apparatuses used by each user 48 (as well as the user group information 50 and the list of apparatuses used by each group 52) cannot be received from the server 14. Being unable to start server-mediated processing, the target user attempts to start direct processing. Before starting direct processing in response to an instruction from the target user, that is, before transmitting a processing command to a processing apparatus 12, the process of steps S32 to S40 is executed.

In step S32, the notification processor 58 refers to the list of apparatuses used by each user 48 (see FIG. 3) stored in the memory 46 and determines whether there is a processing apparatus 12 available among the apparatuses previously used by the target user. The notification processor 58 can determine whether a processing apparatus 12 is currently available by addressing an inquiry about the current state to the processing apparatus 12. FIG. 3 indicates that an apparatus previously used by the target user indicated by “user 11111” is the processing apparatus “MFP-A” only, and thus the notification processor 58 determines whether the processing apparatus “MFP-A” is currently available.

When there is a processing apparatus 12 available among the apparatuses previously used by the target user (“Yes” in step S32), the process proceeds to step S34, and in step S34, the notification processor 58 informs the target user about the processing apparatus 12. In this example, when the processing apparatus “MFP-A” is currently available, the notification processor 58 informs the target user about the processing apparatus “MFP-A”.

When there is no processing apparatus 12 available among the apparatuses previously used by the user, in other words, when the processing apparatus 12 indicated by the apparatus ID associated with the user ID of the target user is unavailable in the list of apparatuses used by each user 48 (“No” in step S32), the process proceeds to step S36. In this example, if the processing apparatus “MFP-A” is currently unavailable, the process proceeds to step S36.

In step S36, the notification processor 58 refers to the list of apparatuses used by each user 48 and the user group information 50 (see FIG. 4), or the list of apparatuses used by each group 52 (see FIG. 5) stored in the memory 46 and determines whether there is a processing apparatus 12 available among the processing apparatuses 12 indicated by the apparatus IDs associated with users being different from the target user and belonging to the user group to which the target user belongs. In other words, the notification processor 58 determines whether there is a processing apparatus 12 available among the apparatuses previously used by the other users belonging to the user group to which the target user belongs. Referring to FIG. 4 or 5, the apparatuses previously used by the respective users belonging to the user group A, to which the target user belongs, are the processing apparatus “MFP-A” and the processing apparatus “MFP-C”. However, since the apparatus previously used by the target user is the processing apparatus “MFP-A”, the apparatus previously used by the other users belonging to the user group to which the target user belongs is the processing apparatus “MFP-C”. Thus, the notification processor 58 determines whether the processing apparatus “MFP-C” is currently available.

When there is a processing apparatus 12 available among the apparatuses previously used by the other users belonging to the user group to which the target user belongs (“Yes” in step S36), the process proceeds to step S34, and in step S34, the notification processor 58 informs the target user about the processing apparatus 12. In this example, the notification processor 58 informs the target user about the processing apparatus “MFP-C”.

When user groups are appropriately formed, an apparatus previously used by the other users is likely to be a processing apparatus 12 that is also easy for the target user to use. For example, when users in the same office room are grouped into the same user group, an apparatus previously used by the other users belonging to the user group to which the target user belongs is a processing apparatus 12 that is also easy for the target user to use (for example, the one installed at a position close to the target user). Thus, if the apparatus previously used by the target user is currently unavailable, the notification processor 58 informs the target user about an apparatus previously used by the other users belonging to the user group to which the target user belongs, as in the present exemplary embodiment, and the target user may be informed about a processing apparatus 12 that is available to the target user and is easy for the target user to use.

In the present exemplary embodiment, the notification processor 58 first informs the target user about a processing apparatus 12 available if there is one among the apparatuses previously used by the target user (steps S32 and S34), and if there is no processing apparatus 12 available among the apparatuses previously used by the target user, the notification processor 58 informs the target user about an apparatus previously used by the other users belonging to the user group to which the target user belongs (steps S36 and S34). That is, the notification processor 58 prioritizes the apparatus previously used by the target user over the apparatus previously used by the other users when informing the target user.

There may be no processing apparatus 12 available among the apparatuses previously used by the other users belonging to the user group to which the target user belongs. In such a case, neither the processing apparatus “MFP-A” nor the processing apparatus “MFP-C” is available in this example, both of the processing apparatuses being previously used by the users belonging to the user group A, to which the target user belongs. In such a case (“No” in step S36), the process proceeds to step S38.

As a prerequisite to step S38, the processing apparatuses 12 and the server 14 are assumed to share the list of apparatuses used by each user 26 and the user group information 28, or the list of apparatuses used by each group 30, as described above. In step S38, the notification processor 58 receives the list of apparatuses used by each user 48 and the user group information 50, or the list of apparatuses used by each group 52, from a processing apparatus 12 indicated by an apparatus ID associated with a user belonging to a user group different from the user group to which the target user belongs. In this example, the notification processor 58 refers to the user group information 50 (see FIG. 4) or the list of apparatuses used by each group 52 and receives the list of apparatuses used by each user 48 and the user group information 50, or the list of apparatuses used by each group 52 from a processing apparatus “MFP-E” associated with users belonging to a user group B, which differs from the user group A, to which the target user belongs.

The list of apparatuses used by each user 48 and the user group information 50, or the list of apparatuses used by each group 52, newly received from the processing apparatus “MFP-E”, is assumed to include a processing apparatus “MFP-F” in addition to the processing apparatuses “MFP-A” and “MFP-C” as an apparatus previously used by the users belonging to the user group A, to which the target user belongs.

In step S40, the notification processor 58 refers to the list of apparatuses used by each user 48 and the user group information 50, or the list of apparatuses used by each group 52 received from the processing apparatus 12 in step S38 and determines again whether there is a processing apparatus 12 available among the processing apparatuses 12 indicated by the apparatus IDs associated with users being different from the target user and belonging to the user group to which the target user belongs. Since the processing apparatuses “MFP-A” and “MFP-C” are already known to be unavailable, the notification processor 58 determines whether the processing apparatus “MFP-F” is currently available.

When the processing apparatus “MFP-F” is available (“Yes” in step S40), the process proceeds to step S34, and in step S34, the notification processor 58 informs the target user about the processing apparatus 12. In this example, the notification processor 58 informs the target user about the processing apparatus “MFP-F”.

When the processing apparatus “MFP-F” is unavailable (“No” in step S40), the notification processor 58 does not inform the target user about the processing apparatus 12. Alternatively, the notification processor 58 may inform the target user that there is no processing apparatus 12 that is easy for the target user to use.

While an exemplary embodiment according to the present disclosure has been described, the present disclosure is not limited to the above-described exemplary embodiment, and various modifications may be made without departing from the spirit of the present disclosure.

In the above-described exemplary embodiment, the server 14 and the user terminals 16 store the list of apparatuses used by each user 26 or 48 indicating apparatuses previously used by “each user” and the user group information 28 or 50 indicating the grouping of “users”. However, when the user terminals 16 used by respective users are fixed, the server 14 and the user terminals 16 may store a list of apparatuses used by each terminal indicating apparatuses previously used by “each user terminal” and terminal group information indicating the grouping of “user terminals”.

The list of apparatuses used by each terminal may be obtained by replacing the user IDs in the list of apparatuses used by each user 26 or 48 illustrated in FIG. 3 with terminal IDs for identifying the user terminals 16. The terminal group information may be obtained by replacing the “user group” in the user group information 28 or 50 illustrated in FIG. 4 with a “terminal group” and replacing user IDs with terminal IDs.

A target user terminal, which is a user terminal 16 used by the target user, is configured to execute a process similar to the process according to the flowchart illustrated in FIG. 8 based on the list of apparatuses used by each terminal and the terminal group information instead of the list of apparatuses used by each user 26 or 48 and the user group information 28 or 50. Specifically, the user of the target user terminal is informed about a processing apparatus 12 indicated by the apparatus ID associated with a user terminal being different from the target user terminal and belonging to the terminal group to which the target user terminal belongs.

While the processing system 10 is a printing system in the above-described exemplary embodiment, the processing system 10 need not be a printing system. The processing system 10 may be any system in which the processing apparatuses 12 may be caused to execute processes according to processing commands through server-mediated processing and direct processing.

In the present exemplary embodiment, each process is executed by a computer of any kind. The computer of any kind may execute these processes by using a processor as hardware, a program as software, or a combination of a processor and a program. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The present disclosure is applicable to a program and a program product.

### Appendix

(((1)))

An information processing system comprising:
a processor configured to:
be able to start server-mediated processing and direct processing, the server-mediated processing causing a processing apparatus to execute a process according to a processing command from a user through mediation by a server, the direct processing causing a processing apparatus to execute a process according to a processing command from a user without mediation by a server;
acquire a list of apparatuses used by each user and predefined user group information, wherein the list is accumulated and stored in the server through repetition of the server-mediated processing in response to instructions from a plurality of users and the list indicates a plurality of combinations each consisting of a user ID for identifying a user and an apparatus ID for identifying a processing apparatus that has executed a process according to a processing command from the user, and wherein the user group information indicates grouping of the plurality of users; and
before starting the direct processing in response to an instruction from a target user, based on the list of apparatuses used by each user and the user group information, inform the target user about the processing apparatus indicated by the apparatus ID associated with one or more users being different from the target user and belonging to a user group to which the target user belongs.
   (((2)))

The information processing system according to (((1))),
wherein the processor is configured to acquire, as the list of apparatuses used by each user and the user group information, a list of apparatuses used by each group in which a group ID for identifying the user group is associated with a user ID of a user belonging to the user group and an apparatus ID for identifying a processing apparatus that has executed a process according to a processing command based on an instruction from a user belonging to the user group.
   (((3)))

The information processing system according to (((1))) or (((2))),
wherein the processor is configured to:
inform the target user about the processing apparatus indicated by the apparatus ID associated with the one or more users different from the target user when the processing apparatus indicated by the apparatus ID associated with the target user is unavailable.
   (((4)))

The information processing system according to any one of (((1))) to (((3))),
wherein the server is configured to transmit the list of apparatuses used by each user and the user group information to the processing apparatus, and
the processor is configured to receive the list of apparatuses used by each user and the user group information from the processing apparatus.
   (((5)))

The information processing system according to (((4))),
wherein the processor is configured to, when all of the processing apparatuses indicated by apparatus IDs associated with users belonging to the user group to which the target user belongs are unavailable, receive the list of apparatuses used by each user and the user group information from the processing apparatus indicated by an apparatus ID associated with a user belonging to a user group different from the user group to which the target user belongs.
   (((6)))

An information processing system comprising:
a processor configured to:
be able to start server-mediated processing and direct processing, the server-mediated processing causing a processing apparatus to execute a process according to a processing command from a user through mediation by a server, the direct processing causing a processing apparatus to execute a process according to a processing command from a user without mediation by a server;
acquire a list of apparatuses used by each terminal and predefined terminal group information, wherein the list is accumulated and stored in the server through repetition of the server-mediated processing in response to instructions from a plurality of users and the list indicates a plurality of combinations each consisting of a terminal ID for identifying a user terminal and an apparatus ID for identifying a processing apparatus that has executed a process according to a processing command transmitted from the user terminal, and wherein the terminal group information indicates grouping of the plurality of user terminals, and;
before executing the direct processing, based on the list of apparatuses used by each terminal and the terminal group information, inform a user of a target user terminal about the processing apparatus indicated by the apparatus ID associated with one or more user terminals being different from the target user terminal and belonging to a terminal group to which the target user terminal belongs.
   (((7)))

A program causing a computer to execute a process for information processing, the process comprising:
being able to start server-mediated processing and direct processing, the server-mediated processing causing a processing apparatus to execute a process according to a processing command from a user through mediation by a server, the direct processing causing a processing apparatus to execute a process according to a processing command from a user without mediation by a server;
acquiring a list of apparatuses used by each user and predefined user group information, wherein the list is accumulated and stored in the server through repetition of the server-mediated processing in response to instructions from a plurality of users and the list indicates a plurality of combinations each consisting of a user ID for identifying a user and an apparatus ID for identifying a processing apparatus that has executed a process according to a processing command from the user, and wherein the user group information indicates grouping of the plurality of users; and
before starting the direct processing in response to an instruction from a target user, based on the list of apparatuses used by each user and the user group information, informing the target user about the processing apparatus indicated by the apparatus ID associated with one or more users being different from the target user and belonging to a user group to which the target user belongs.

What is claimed is:

1. An information processing system comprising:
a processor configured to:
be able to start server-mediated processing and direct processing, the server-mediated processing causing a processing apparatus to execute a process according to a processing command from a user through mediation by a server, the direct processing causing a processing apparatus to execute a process according to a processing command from a user without mediation by a server;
acquire a list of apparatuses used by each user and predefined user group information, wherein the list is accumulated and stored in the server through repetition of the server-mediated processing in response to instructions from a plurality of users and the list indicates a plurality of combinations each consisting of a user ID for identifying a user and an apparatus ID for identifying a processing apparatus that has executed a process according to a processing command from the user, and wherein the user group information indicates grouping of the plurality of users; and
before starting the direct processing in response to an instruction from a target user, based on the list of apparatuses used by each user and the user group information, inform the target user about the processing apparatus indicated by the apparatus ID associated with one or more users being different from the target user and belonging to a user group to which the target user belongs.

2. The information processing system according to claim 1,
wherein the processor is configured to acquire, as the list of apparatuses used by each user and the user group information, a list of apparatuses used by each group in which a group ID for identifying the user group is associated with a user ID of a user belonging to the user group and an apparatus ID for identifying a processing apparatus that has executed a process according to a processing command based on an instruction from a user belonging to the user group.

3. The information processing system according to claim 1,
wherein the processor is configured to:
inform the target user about the processing apparatus indicated by the apparatus ID associated with the one or more users different from the target user when the processing apparatus indicated by the apparatus ID associated with the target user is unavailable.

4. The information processing system according to claim 2,
wherein the processor is configured to:
inform the target user about the processing apparatus indicated by the apparatus ID associated with the one or more users different from the target user when the processing apparatus indicated by the apparatus ID associated with the target user is unavailable.

5. The information processing system according to claim 1,
wherein the server is configured to transmit the list of apparatuses used by each user and the user group information to the processing apparatus, and
the processor is configured to receive the list of apparatuses used by each user and the user group information from the processing apparatus.

6. The information processing system according to claim 5,
wherein the processor is configured to, when all of the processing apparatuses indicated by apparatus IDs associated with users belonging to the user group to which the target user belongs are unavailable, receive the list of apparatuses used by each user and the user group information from the processing apparatus indicated by an apparatus ID associated with a user belonging to a user group different from the user group to which the target user belongs.

7. An information processing system comprising:
a processor configured to:
be able to start server-mediated processing and direct processing, the server-mediated processing causing a processing apparatus to execute a process according to a processing command from a user through mediation by a server, the direct processing causing a processing apparatus to execute a process according to a processing command from a user without mediation by a server;
acquire a list of apparatuses used by each terminal and predefined terminal group information, wherein the list is accumulated and stored in the server through repetition of the server-mediated processing in response to instructions from a plurality of users and the list indicates a plurality of combinations each consisting of a terminal ID for identifying a user terminal and an apparatus ID for identifying a processing apparatus that has executed a process according to a processing command transmitted from the user terminal, and wherein the terminal group information indicates grouping of the plurality of user terminals; and
before executing the direct processing, based on the list of apparatuses used by each terminal and the terminal group information, inform a user of a target user terminal about the processing apparatus indicated by the apparatus ID associated with one or more user terminals being different from the target user terminal and belonging to a terminal group to which the target user terminal belongs.

8. A non-transitory computer readable medium storing a program causing a computer to execute a process for information processing, the process comprising:
being able to start server-mediated processing and direct processing, the server-mediated processing causing a processing apparatus to execute a process according to a processing command from a user through mediation by a server, the direct processing causing a processing apparatus to execute a process according to a processing command from a user without mediation by a server;
acquiring a list of apparatuses used by each user and predefined user group information, wherein the list is accumulated and stored in the server through repetition of the server-mediated processing in response to instructions from a plurality of users and the list indicates a plurality of combinations each consisting of a user ID for identifying a user and an apparatus ID for identifying a processing apparatus that has executed a process according to a processing command from the user, and wherein the user group information indicates grouping of the plurality of users; and
before starting the direct processing in response to an instruction from a target user, based on the list of apparatuses used by each user and the user group information, informing the target user about the processing apparatus indicated by the apparatus ID associated with one or more users being different from the target user and belonging to a user group to which the target user belongs.
